(19) United States
(12) Patent Application Publication
(10) Pub. No.: US 2026/0343129 A1
(43) Pub. Date: Oct. 29, 2026

(54) MICROPHONE TECHNOLOGIES

(71) Applicant: Christopher Renwick Alston, Miami, FL (US)

(72) Inventor: Christopher Renwick Alston, Miami, FL (US)

(21) Appl. No.: 18/831,564

(22) PCT Filed: Oct. 27, 2023
(86) PCT No.: PCT/US2023/036147

§ 371 Date: Apr. 25, 2025

(51) Int. Cl. H04R 1/08; H04R 1/1025

(52) U.S. Cl. CPC H04R 1/083; H04R 1/1025; H04R 2410/07; H04R 2460/17

(57) ABSTRACT

This disclosure enables a device, which may be a portable audio input unit (e.g., a portable handheld microphone), that may be enabled to (i) reduce an audio distortion resulting from an airflow, whether natural, such as a wind, or man-made, such as from a set of vanes from a fan, whether a floor fan, a ceiling fan, or a portable fan, (ii) be or used as a case for storing an accessory, such as an earbud, a door key, a memory card, a memory stick, or another suitable accessory, (iii) be mountable onto a hook, a line, such as a cable, a rope, a chain, or a belt, or another suitably elongated member, or (iv) be capable of pairing with another electronic device over a PAN protocol, such as Bluetooth, IrDA, or another suitable protocol.

### CROSS-REFERENCE TO RELATED PATENT APPLICATION

This patent application claims a benefit of priority to U.S. provisional patent application 63/420,258 filed on 28 Oct. 2022, which is incorporated by reference herein for all purposes.

### BACKGROUND

A person may desire to have a portable audio input unit (e.g., a portable handheld microphone) that is enabled to reduce an audio distortion resulting from an airflow, whether natural, such as a wind, or man-made, such as from a set of vanes from a fan, whether a floor fan, a ceiling fan, or a portable fan. Further, the person may desire that the portable audio input unit be used as a case for storing an accessory, such as an earbud, a door key, a memory card, a memory stick, or another suitable accessory. Additionally, the person may desire to have the portable audio input unit be mountable onto a hook, a line, such as a cable, a rope, a chain, or a belt, or another suitably elongated member. Additionally, the person may desire to have the portable audio input unit be capable of pairing with another electronic device over a personal area network (PAN) protocol, such as Bluetooth, IrDA, or another suitable protocol.

This disclosure enables a device, which may be a portable audio input unit (e.g., a portable handheld microphone), that may be enabled to (i) reduce an audio distortion resulting from an airflow, whether natural, such as a wind, or man-made, such as from a set of vanes from a fan, whether a floor fan, a ceiling fan, or a portable fan, (ii) be or used as a case for storing an accessory, such as an earbud, a door key, a memory card, a memory stick, or another suitable accessory, (iii) be mountable onto a hook, a line, such as a cable, a rope, a chain, or a belt, or another suitably elongated member, or (iv) be capable of pairing with another electronic device over a PAN protocol, such as Bluetooth, IrDA, or another suitable protocol.

### DESCRIPTION OF DRAWINGS

FIGS. 1-3 show an embodiment of a portable audio unit freely resting on a flat surface, according to this disclosure.

FIG. 4 shows an embodiment of an extension of a portable audio unit with a set of microphones and a set of light sources, according to this disclosure.

FIG. 5 shows an embodiment of a portable audio unit in a closed configuration and an open configuration, according to this disclosure.

FIG. 6 shows an embodiment of a tray of a portable audio unit for storing a pair of in-ear headphones, according to this disclosure.

FIG. 7 shows an embodiment of a lower portion of a portable audio unit with an internal battery, where the lower portion hosts a standardized port (e.g., a USB port) for recharging the battery, without interfering with the portable audio unit being freely restable on a flat surface, and where the lower portion hosts a cord (e.g., a lanyard) capable of being handheld or looped around or adjustably tightened around a human wrist, according to this disclosure.

FIG. 8 shows an embodiment of a portable audio unit being handheld by a user for singing thereinto according to this disclosure.

FIG. 9 shows an embodiment of a portable audio unit without a cord, without a standardized port, and that is not capable of freely resting on a flat surface, according to this disclosure.

### DETAILED DESCRIPTION

As explained above, this disclosure enables a device, which may be a portable audio input unit (e.g., a portable handheld microphone), that may be enabled to (i) reduce an audio distortion resulting from an airflow, whether natural, such as a wind, or man-made, such as from a set of vanes from a fan, whether a floor fan, a ceiling fan, or a portable fan, (ii) be or used as a case for storing an accessory, such as an earbud, a door key, a memory card, a memory stick, or another suitable accessory, (iii) be mountable onto a hook, a line, such as a cable, a rope, a chain, or a belt, or another suitably elongated member, or (iv) be capable of pairing with another electronic device over a PAN protocol, such as Bluetooth, IrDA, or another suitable protocol.

This disclosure is now described more fully with reference to all attached figures, in which some embodiments of this disclosure are shown. This disclosure may, however, be embodied in many different forms and should not be construed as necessarily being limited to various embodiments disclosed herein. Rather, these embodiments are provided so that this disclosure is thorough and complete, and fully conveys various concepts of this disclosure to skilled artisans. Note that like numbers or similar numbering schemes can refer to like or similar elements throughout.

Various terminology used herein can imply direct or indirect, full or partial, temporary or permanent, action or inaction. For example, when an element is referred to as being “on,” “connected” or “coupled” to another element, then the element can be directly on, connected or coupled to the other element or intervening elements can be present, including indirect or direct variants. In contrast, when an element is referred to as being “directly connected” or “directly coupled” to another element, there are no intervening elements present.

As used herein, a term “or” is intended to mean an inclusive “or” rather than an exclusive “or.” That is, unless specified otherwise, or clear from context, “X employs A or B” is intended to mean any of natural inclusive permutations. That is, if X employs A; X employs B; or X employs both A and B, then “X employs A or B” is satisfied under any of the foregoing instances. For example, X includes A or B can mean X can include A, X can include B, and X can include A and B, unless specified otherwise or clear from context.

As used herein, each of singular terms “a,” “an,” and “the” is intended to include a plural form (e.g., two, three, four, five, six, seven, eight, nine, ten, tens, hundreds, thousands, millions) as well, including intermediate whole or decimal forms (e.g., 0.0, 0.00, 0.000), unless context clearly indicates otherwise. Likewise, each of singular terms “a,” “an,” and “the” shall mean “one or more,” even though a phrase “one or more” may also be used herein.

As used herein, each of terms “comprises,” “includes,” or “comprising,” “including” specify a presence of stated features, integers, steps, operations, elements, or components, but do not preclude a presence or addition of one or more other features, integers, steps, operations, elements, components, or groups thereof.

As used herein, when this disclosure states herein that something is “based on” something else, then such statement refers to a basis which may be based on one or more other things as well. In other words, unless expressly indicated otherwise, as used herein “based on” inclusively means “based at least in part on” or “based at least partially on.”

As used herein, terms, such as “then,” “next,” or other similar forms are not intended to limit an order of steps. Rather, these terms are simply used to guide a reader through this disclosure. Although process flow diagrams may describe some operations as a sequential process, many of those operations can be performed in parallel or concurrently. In addition, the order of operations may be re-arranged.

As used herein, a term “response” or “responsive” are intended to include a machine-sourced action or inaction, such as an input (e.g., local, remote), or a user-sourced action or inaction, such as an input (e.g., via user input device).

As used herein, a term “about” or “substantially” refers to a +/−10% variation from a nominal value/term.

Although various terms, such as first, second, third, and so forth can be used herein to describe various elements, components, regions, layers, or sections, note that these elements, components, regions, layers, or sections should not necessarily be limited by such terms. Rather, these terms are used to distinguish one element, component, region, layer, or section from another element, component, region, layer, or section. As such, a first element, component, region, layer, or section discussed below could be termed a second element, component, region, layer, or section, without departing from this disclosure.

Unless otherwise defined, all terms (including technical and scientific terms) used herein have a same meaning as commonly understood by skilled artisans to which this disclosure belongs. These terms, such as those defined in commonly used dictionaries, should be interpreted as having a meaning that is consistent with their meaning in context of relevant art and should not be interpreted in an idealized or overly formal sense, unless expressly so defined herein.

Features or functionality described with respect to certain embodiments may be combined and sub-combined in or with various other embodiments. Also, different aspects, components, or elements of embodiments, as disclosed herein, may be combined and sub-combined in a similar manner as well. Further, some embodiments, whether individually or collectively, may be components of a larger system, wherein other procedures may take precedence over or otherwise modify their application. Additionally, a number of steps may be required before, after, or concurrently with embodiments, as disclosed herein. Note that any or all methods or processes, as disclosed herein, can be at least partially performed via at least one entity or actor in any manner.

Hereby, all issued patents, published patent applications, and non-patent publications that are mentioned or referred to in this disclosure are herein incorporated by reference in their entirety for all purposes, to a same extent as if each individual issued patent, published patent application, or non-patent publication were specifically and individually indicated to be incorporated by reference. To be even more clear, all incorporations by reference specifically include those incorporated publications as if those specific publications are copied and pasted herein, as if originally included in this disclosure for all purposes of this disclosure. Therefore, any reference to something being disclosed herein includes all subject matter incorporated by reference, as explained above. However, if any disclosures are incorporated herein by reference and such disclosures conflict in part or in whole with this disclosure, then to an extent of the conflict or broader disclosure or broader definition of terms, this disclosure controls. If such disclosures conflict in part or in whole with one another, then to an extent of conflict, the later-dated disclosure controls.

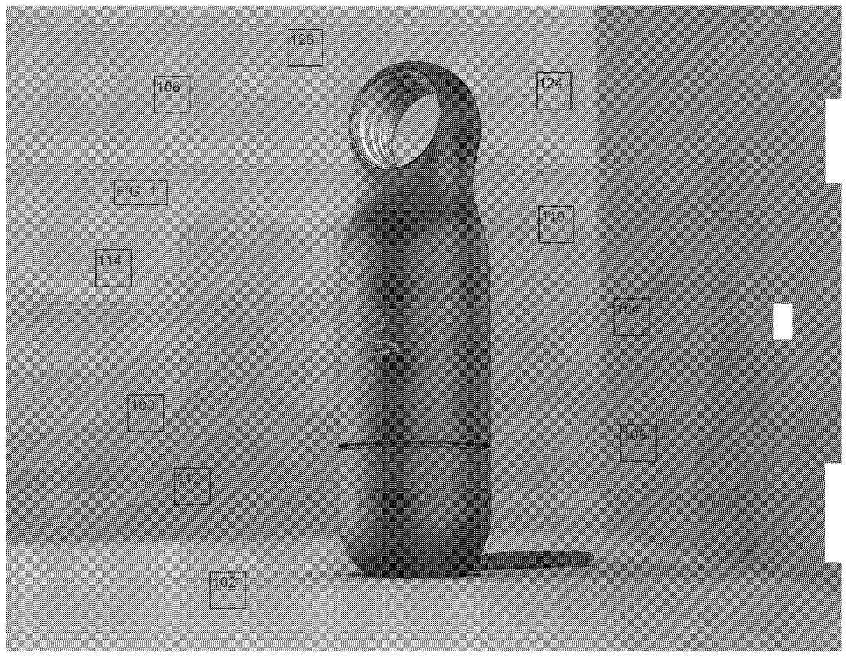

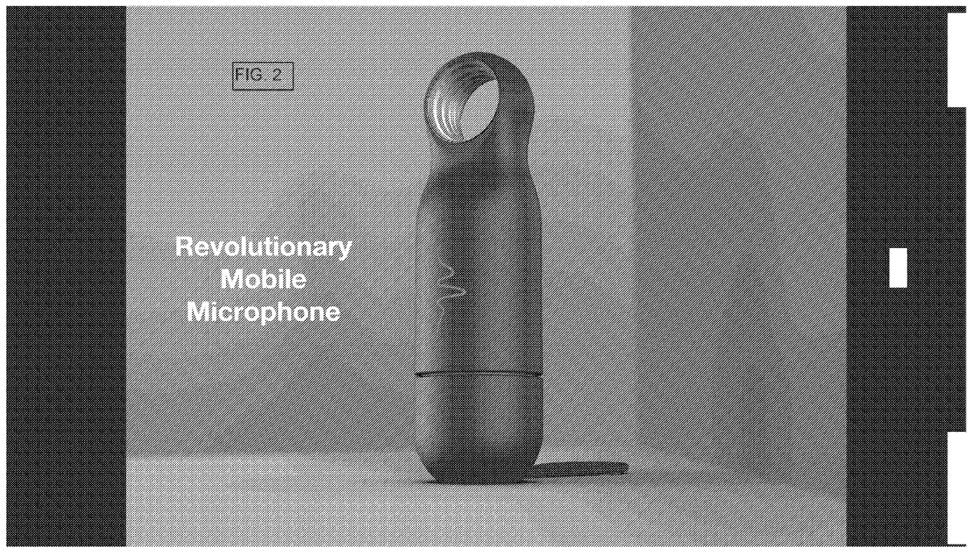

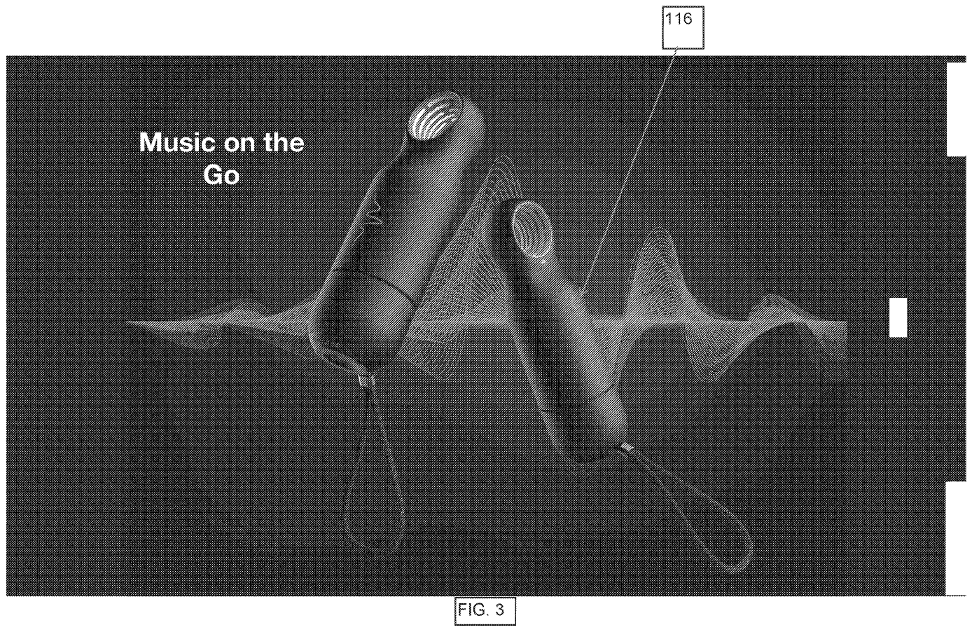

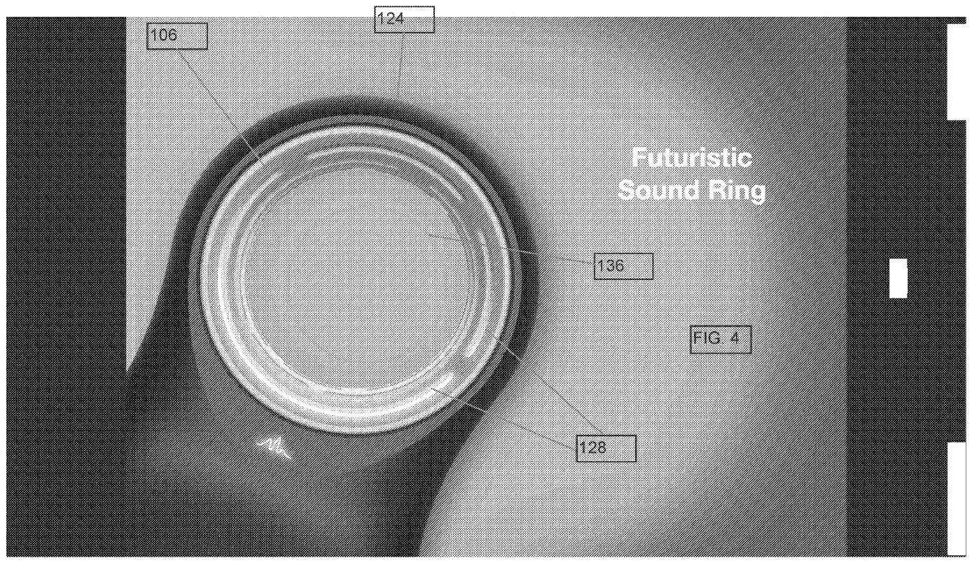

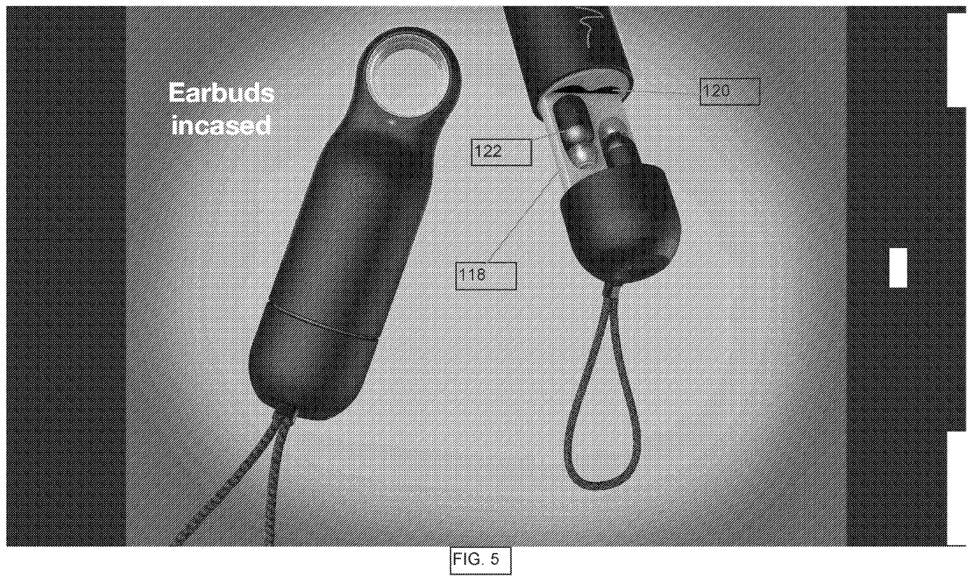

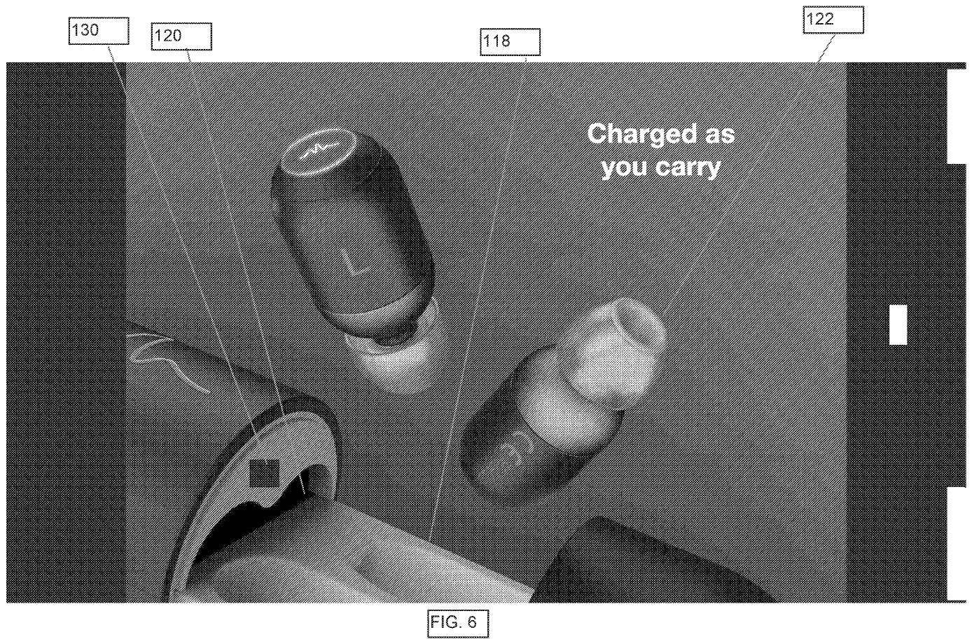

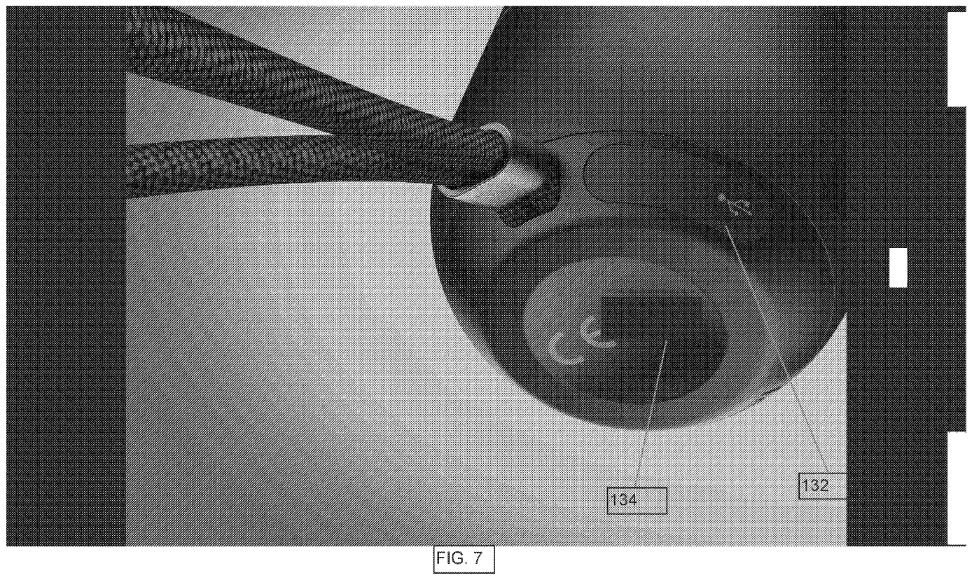

FIGS. 1-3 show an embodiment of a portable audio unit freely resting on a flat surface, according to this disclosure. FIG. 4 shows an embodiment of an extension of a portable audio unit with a set of microphones and a set of light sources, according to this disclosure. FIG. 5 shows an embodiment of a portable audio unit in a closed configuration and an open configuration, according to this disclosure. FIG. 6 shows an embodiment of a tray of a portable audio unit for storing a pair of in-ear headphones, according to this disclosure. FIG. 7 shows an embodiment of a lower portion of a portable audio unit with an internal battery, where the lower portion hosts a standardized port (e.g., a USB port) for recharging the battery, without interfering with the portable audio unit being freely restable on a flat surface, and where the lower portion hosts a cord (e.g., a lanyard) capable of being handheld or looped around or adjustably tightened around a human wrist, according to this disclosure. In particular, there is a portable audio unit 100 freely resting upright on a flat surface 102. The portable audio unit 100 includes a housing 104 (e.g., handheld), a processor (e.g., a controller, a microprocessor, a PLC, an ASIC), a memory (e.g., a flash memory, a ROM, a RAM), a transmitter (e.g., an RF transmitter, an RF transceiver), a charger, a port, a set of microphones 106, a first light source 128, a second light source 130, a third light source 134, a button 116, and a cord 108, some, many, most, or all of which may be optional or omitted.

The housing 104 houses the processor, the memory, the transmitter, the charger, the port, the set of microphones 106, the first light source 128, the second light source 130, the third light source 134, the button 116, and the cord 108, whether internally or externally. The processor is coupled to the memory, the transmitter, the charger, the port, the set of microphones 106, the first light source 128, the second light source 130, and the third light source 134 to control foregoing.

The battery, which may be rechargeable, powers the processor, the memory, the transmitter, the charger, the port 132 (if needed to charge the accessory 122 or another device which may be handheld or portable), the set of microphones 106, the first light source 128, the second light source 130, and the third light source, when some, many, most, or all of these components are present. For example, the battery may be permanent or removable (e.g., for swapping). For example, the battery may be a AA battery, a AAA battery, a flat battery, or another suitable battery form factor.

The housing 104 contains a compartment 120 to store a tray 118 hosting an accessory 122, such as a pair of in-ear headphones, an earbud, a key, a memory card, a memory stick, or another suitable accessory. For example, the tray 118 may include a pair of dedicated slots or wells to host a pair of in-ear headphones, as shown in FIG. 6. The housing 104 is cylindrical, but can be shaped differently. The housing 104 includes a first portion (e.g., an upper portion) 110 and a second portion (e.g., a lower portion) 112, where the first portion 110 may contain the compartment 120. The housing 104 may be formed by the first portion 110 removably attaching to the second portion 112 or vice versa (e.g., fastening, threading, mating, interlocking, magnetizing). For example, the second portion 112 may slide out/in from the first portion 110 or fasten/mate to the first portion 110 to control access to the compartment 120 or the tray 118 or otherwise be removably attachable from or openable/closeable with respect to or using the first portion 110 to control access to the compartment 120 or the tray 118, without interfering with the accessory 122 when the compartment hosts the accessory 122. The tray 118 extends, which may be cantileveredly, from the second portion 112. The first portion 110 or the tray 118 may have a guard (e.g., a travel range limiter, a bump, a stop) installed to prevent the tray 118 from being completely detached from the first portion 110. The guard may be positioned on the tray 118 or the first portion 110 distal to the second portion 112 when the housing 102 is in the open configuration, pursuant to FIGS. 5-6.

The housing 104 has a sidewall, which is formed by a first sub-sidewall on the first portion 110 and a second sub-sidewall on the second portion 112. The first sub-sidewall or the second sub-sidewall can host the button 116. The button 116 is presented as a single physical button. However, the button 116 can be a virtual button when the housing 104 (e.g., the upper portion 110) hosts a display (e.g., a touchscreen), whether on the first portion 110 or the second portion 112. Likewise, although the button 116 is presented a single physical button, there may be a physical user interface (e.g., a knob, switch) or a virtual user interface (e.g., a virtual knob, a virtual switch), whether on the first portion 110 or the second portion 112. Note that the housing 104 may host a logo 114, whether printed, painted, embossed, or otherwise suitably disposed thereon. For example, the logo 114 is disposed on the first sub-sidewall, the logo 114 may disposed on the second sub-sidewall or somewhere else (e.g., topmost or bottommost side). The logo 114 may be physical as shown in FIG. 1 or virtual (e.g., when the housing 104 hosts a display). The logo 114 may be omitted.

The compartment 120 or the tray 118 includes the charger to charge the accessory 122, whether the charger is wired, such as with a plug, or wireless, such as via an induction coil, if the accessory 122 is chargeable. The tray 118 may contain a dedicated spot, such as a slot or a well, to host the accessory 122, as shown in FIGS. 5-6. The housing 104 includes the cord 108 extending therefrom, whether the first portion 110 or the second portion 112. The cord 108 may be looped such that its ends extend from the housing 104, whether the first portion 110 or the second portion 112, to be used as a looped handle (e.g., a lanyard).

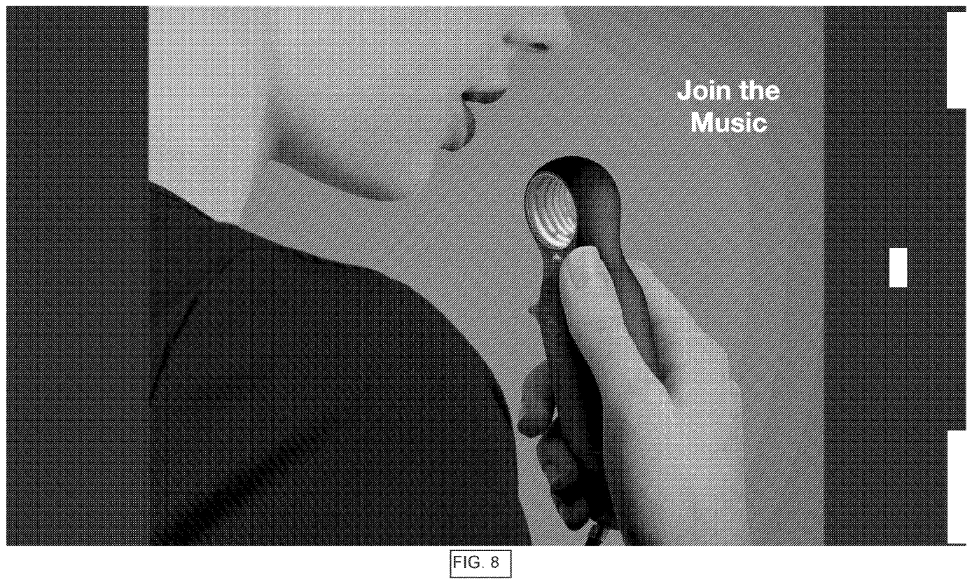

There is an extension 124 extending from the housing 104, where the extension 124 is monolithic or assembled (e.g., fastened, mated, magnetized) with the housing 104, whether with the first portion 110 or the second portion 112. The extension 124 has an interior side 126 defining a closed-shape, whether alone or together with the housing 104, such as an O-shape, a D-shape, a 0-shape, a circular shape, an oval shape, a polygonal shape, a square shape, a triangular shape, a pentagonal shape, a hexagon shape, a teardrop shape, or any other suitable shape. For example, the extension 124 may have a U-shape or a C-shape, but the closed-shape is defined together with the housing 104. For example, the extension 124 may be O-shaped and extending from the housing 104, whether directly or via a structural member, whether hollow or solid, such as a column, a bar, a tubular member, or another suitable structural member, spanning therebetween, whether monolithically or assembled therewith (e.g., fastening, mating, magnetizing). By having the closed-shape, the interior side 126 defines a channel or open space 136 through which the user may sing or talk, as shown in FIG. 8, whether from a specific side (e.g., front or rear) or from both sides (e.g., front and rear). Although the channel or open space 136 is circular, this shaping is not required. For example, the channel or open space 136 may be square, rectangular, triangular, pentagonal, teardrop, oval, ovoid, pentagram, star, or another suitable shape.

The interior side 126 has the set of microphones 106 disposed therealong, whether randomly or in a pattern, such as based on a distance therebetween, an angle therebetween, or others, whether along an X, Y, or Z plane. For example, the set of microphones 106 may be disposed parallel to each other, distributed along a common path, or another suitable way. For example, the set of microphones 106 can be positioned at 12 o'clock, 3 o'clock, 6 o'clock, and 9 o'clock, whether by itself, or there can be multiple sets of microphones 106 disposed in similar positioning or dissimilar positioning, whether parallel or not parallel (e.g., intersecting or potentially intersecting if continued). For example, the set of microphones 106 may be arranged in a set of linear broken patterns, with such microphones 106 being spaced apart from each other in each of those patterns, whether those patterns are parallel to each other or not (e.g., intersecting or potentially intersecting if continued), whether those microphones 106 in those patterns overlap or oppose each other or not. For example, the set of microphones 106 may be arranged according to an open shape (e.g., a C-shape, a U-shape), or a closed shape (e.g., an O-shape, a D-shape, a 0 shape). For example, the set of microphones 106 may be a single line, whether in an open shape (e.g., a C-shape, a U-shape) or a closed shape (e.g., an O-shape, a D-shape, a 0 shape). For example, the interior side 126 may have a set of openings through which the set of microphones 106 protrudes inwardly or outwardly, or extend therein. For example, if there are any gaps between those openings and those microphones 106, then those gaps may be sealed or gasketed (e.g., waterproofing, dustproofing). For example, the set of microphones 106 includes at least two microphones, which may include three, four, five, six, seven, eight, nine, ten, tens, hundred, hundreds, or more, including whole intermediate values, such as eleven, twenty three, or others, although a single microphone 106 is possible. The set of microphones 106 may have wiring, which may extend to the processor, whether internal or external to the housing 104. If the set of microphones 106 is not always active, depending on the battery being charged, then the housing 106 may have the button 116 for a power on/off, or a power on button 116 and a power off button 116, whether on the first portion 110 or the second portion 112. By having the closed-shape, the set of microphones 106 disposed on the interior side 124 is positioned to reduce an audio distortion resulting from an airflow, whether natural, such as a wind, or man-made, such as from a set of vanes from a fan, whether a floor fan, a ceiling fan, or a portable fan. The set of microphones 106 is able to capture a set of sounds when a person outputs (e.g., talks, sings) the set of sounds into the closed-shape, as shown in FIG. 8. The set of sounds are stored in the memory, which may be persistent or volatile. By having the closed-shape, the extension 124 may also be mountable onto a hook, a line, such as a cable, a rope, a chain, or a belt, or another suitably elongated member. The processor may cause the set of sounds or copies thereof to be send by the transmitter to another computing device (e.g., a smartphone, a laptop, the accessory 122 storable in the compartment 120 or the tray 118). The transmitter may be a wireless transmitter (e.g., a wireless transceiver) capable of pairing with another computing device or an accessory over a PAN protocol, such as Bluetooth, IrDA, or another suitable protocol. For example, the computing device may include a smartphone or a laptop, and the accessory 122 may include a set of earbuds or another suitable accessory, whether or not pairable by the PAN protocol.

The interior side 126 may have the first light source 128 may be disposed thereon, whether similarly to the set of microphones 106, as explained above, or not. The first light source 128 may be a single light source or a set of light sources, such as a light emitting diode (LED) or another suitable light source, whether of a single color or multiple colors, which may be illuminating when the set of microphones 106 is active to receive the set of sounds, to provide a visual indicator of being active and correspondingly not active when the set of microphones 106 is not active to receive the set of sounds. The first light source 128 may be illuminated continuously when the set of microphones 106 is active to receive the set of sounds and not illuminate at all when the set of microphones 106 is not active to receive the set of sounds. The first light source 128 may pulsate according to a preset frequency or based on the set of sounds input into the set of microphones (e.g., based on corresponding sound processing). The first light source 128 may be disposed on the housing 104, whether the first portion 110 or the second portion 112.

The second light source 130 may be disposed to illuminate the compartment 120 or the tray 118 (e.g., which may include a slot or a well for the accessory 122) to deposit or withdraw the accessory 122 therefrom. The second light source 130 may be a single light source or a set of light sources, such as a light emitting diode (LED) or another suitable light source, whether of a single color or multiple colors. The second light source 130 may be a single light source or a set of light sources, such as a light emitting diode (LED) or another suitable light source, whether of a single color or multiple colors, which may be illuminating when the set of microphones 106 is active to receive the set of sounds, to provide a visual indicator of being active and correspondingly not active when the set of microphones 106 is not active to receive the set of sounds. The second light source 130 may be automatically activated (e.g., via a trigger) when the tray 118 or the compartment 120 is accessible. The button 116 may be pressed until the third second source 130 is activated or deactivated.

The port 132 is configured to receive a cable (e.g., a USB cable), whether charging or data, to charge the battery when the cable is also connected to a power source, such as an adapter, an outlet, a computing device, or another suitable power source, or communicate copies of the set of sounds from the memory to another computing device when the cable is also connected to a computing device, such as a smartphone, a laptop. The port 132 may be on the first portion 110 or the second portion 112. The port 132 may also enable to charge another device (e.g., the accessory 122, a computing device, a flashlight) connected to the cable when the cable spans between the port 132 and that device.

The second portion 112 may include a third light source 134 disposed to enable the housing 104 to operate as a flashlight. The third light source 134 may be a single light source or a set of light sources, such as a light emitting diode (LED) or another suitable light source, whether of a single color or multiple colors, which may be illuminating when the set of microphones 106 is active to receive the set of sounds, to provide a visual indicator of being active and correspondingly not active when the set of microphones 106 is not active to receive the set of sounds. The button 116 may be pressed until the third light source 134 is activated or deactivated. The third light source 134 may be activated by an activation shaking pattern and then deactivated by a deactivation shaking pattern.

Some embodiments may enable a portable system (the housing 104 with the set of microphones 106 and encasing a set of earbuds) with Bluetooth capabilities. Consumers will be able to use this system where Bluetooth is compatible as well as within a game metaverse where more capabilities will unlock.
PORTABILITY: The portable system is a lightweight rechargeable model that allows users to travel therewith and record quality audio to an external device.
IMMERSIVE EXPERIENCE: This system is believed to be a first of its kind to include earbuds/carrying case in one unit for a compact mobile recording suite. Typically artists sing on a sound proofed studio which allows them to hear their pitch better. The set of earbuds that is Bluetooth connected to the transmitter housed by the housing give this system studio experience on the go.
NOISE FILTRATION: The set of microphones disposed along the interior side defining the closed-shape may include a set of directional mics pointed inward minimizing some effects of surrounding noise, which may include airflow. This design increases the system's portable utility.
VOICE DIRECTION & FEEDBACK: When a person sings or speaks into the set of microphones, the first light source is active on the interior side defining the closed-shapeto direct and give feedback to the person to optimize vocal conditions (i.e., too close, too far, too loud, too loud of surroundings, clarity of voice) based on certain audio algorithms running on the processor on the set of sounds.

FIG. 8 shows an embodiment of a portable audio unit being handheld by a user for singing thereinto according to this disclosure, as explained above. For example, the user may sing into the extension 124 along the inner side 126.

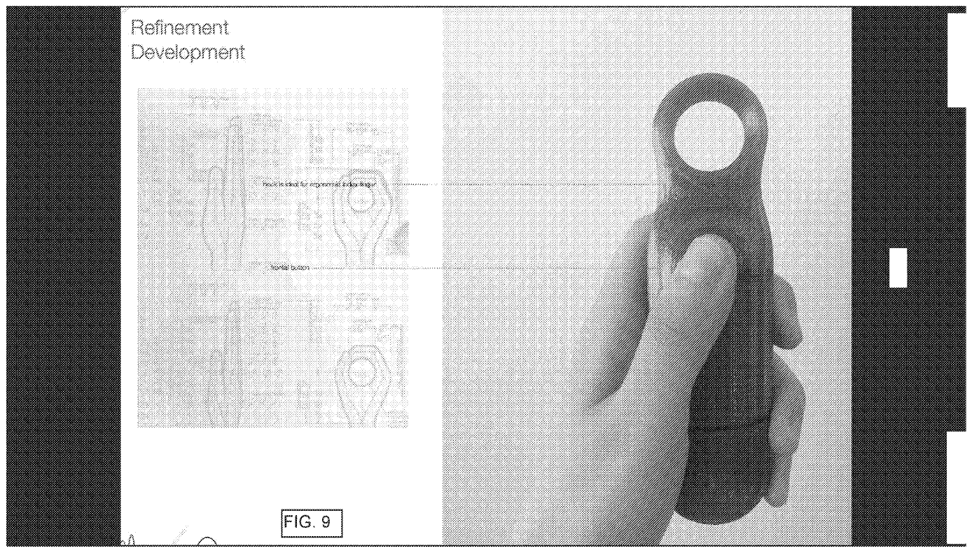

FIG. 9 shows an embodiment of a portable audio unit without a cord, without a standardized port, and that is not capable of freely resting on a flat surface, according to this disclosure.

Various embodiments of the present disclosure may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

This disclosure may be embodied in a system, a method, and/or a computer program product. The computer program product may include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In various embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. The various illustrative logical blocks, modules, circuits, and algorithm steps described in connection with the embodiments disclosed herein may be implemented as electronic hardware, computer soft-ware, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

Although various embodiments have been depicted and described in detail herein, skilled artisans know that various modifications, additions, substitutions and the like can be made without departing from this disclosure. As such, these modifications, additions, substitutions and the like are considered to be within this disclosure.

1. A device, comprising:
a handheld housing;
an extension extending from the handheld housing, wherein the extension has an interior side defining a closed shape;
a battery, wherein the handheld housing houses the battery; and
a microphone disposed along the interior side, wherein the battery is configured to power the microphone.

2. The device of claim 1, wherein the handheld housing has a compartment configured to store an accessory.

3. The device of claim 2, wherein the battery charges the accessory when the accessory is stored in the housing.

4. The device of claim 1, further comprising:
a light source disposed along the interior side, wherein the battery is configured to power the light source such that the light source is activatable when the microphone is receiving a sound from a user talking or singing into the microphone.
